(19) United States
(12) Patent Application Publication
(10) Pub. No.: US 2021/0215272 A1
(43) Pub. Date: Jul. 15, 2021

(54) PIPE CLAMP

(71) Applicant: Zheng Kai Hardware Products (Nantong) Co., Ltd., Nantong City (CN)

(72) Inventor: Shwu-Ruu Chern, Taichung (TW)

(21) Appl. No.: 16/738,799

(22) Filed: Jan. 9, 2020

(51) Int. Cl. F16L 3/10

(52) U.S. Cl. CPC F16L 3/1033; F16L 3/1058

(57) ABSTRACT

A pipe clamp includes a first clamp body, a second clamp body, an engaging member, a linking engagement member, a driver, at least one stop portion and a moving stopper. The moving stopper is used to control the first and second clamp bodies into a locked or swingable status. In the locked status, the second clamp body swings to a swing angle to drive the driver to link and pivot the linking engagement member, so that the serrated portion of the linking engagement member and the gear rack of the engaging member are engaged with each other in a one-way limit manner, and the first and second clamp bodies can swing in one direction only. The pipe clamp has the advantages of clamping a pipe stably, saving efforts, and improving the convenience of use.

### 1. DESCRIPTION OF THE RELATED ART

In general, it is necessary to sheath a copper-sleeved joint on a gating by a pipe clamp in order to connect a hose to the copper-sleeved joint, so that the hose can be combined and secured with the joint stably. A conventional pipe clamp is usually made up of a pair of crossly pivoted clamp bodies, and an arc jaw is formed at an end of each clamp body. After the hose and the copper-sleeved joint are placed between the arc jaws, a force can be applied to press the clamp bodies to carry out a pipe clamping operation by the arc jaws. Although the structure of this sort has been used in different ways to achieve the basic pipe clamping function, it is necessary to apply a very large force to press the clamp bodies back and forth, and the reaction force produced in the pipe clamping process may cause an unstable clamping operation and loosen the clamped hose and joint easily. Obviously, the conventional pipe clamp requires too much laborious effort and has uncertainty about a stable clamping process.

Furthermore, the conventional arc jaws are generally integrally formed with the clamp bodies as one piece, so that the conventional pipe clamp can only be applied to the hoses of one size. As a result, different-sized pipe clamps are required for clamping the hoses of different sizes, and thus causing tremendous inconvenience to users. Some manufacturers have developed a detachable arc-shaped jaw to overcome the aforementioned problem, wherein a positioning slot 3 is formed at a relative position of a jaw opening land a clamp head 2 (which is the aforementioned detachable arc-shaped jaw), and a locking hole 4 is formed at a relative position of the jaw opening 1 and the positioning slot 3, and then a bolt 5 is inserted into the positioning slot 3 to lock the clamp head 2 to the jaw opening 1. However, if a user wants to replace the clamp head 2, the user not just needs to prepare an additional removal tool only, but also needs to repeat the removing and fixing steps. Obviously, the conventional pipe clamp is very inconvenient.

### 2. SUMMARY OF THE INVENTION

Therefore, it is a primary objective of the present invention to provide a pipe clamp with the features of clamping a pipe stably, saving efforts, and improving the convenience of use.

Another objective of the present invention is to provide a pipe clamp having a quick-replaceable jaw block capable of achieving a quick removal without requiring an additional removal tool as well as providing a multiple of functions and improving the convenience of installation and removal.

To achieve the aforementioned and other objectives, the present invention provides a pipe clamp, comprising: a first clamp body, having a first operating section and a first clamp portion disposed at an end of the first operating section;

a second clamp body, having a second operating section, an installation section, and a second clamp portion disposed at an end of the installation section, wherein a connector is pivotally installed at a predetermined position of the first and second clamp bodies, so that the first and second clamp bodies can swing apart from each other to define an open status or towards each other to define a pressing operation status;

an engaging member, installed at the first operating section, and having a gear rack disposed on a side of the engaging member;

a linking engagement member, pivoted to the installation section of the second clamp body by a first pivot, and comprising a serrated portion and an elastic element, and the elastic element being installed at an end other than the serrated portion, so that the linking engagement member can be set into a pivotable and elastically restoring status by using the first pivot as an axis, and the serrated portion is engaged with the gear rack of the engaging member in a one-way engagement limit manner, and if the linking engagement member is in an engaged status, the first and second clamp bodies will be limited to swing in one direction only;

a driver, pivoted to the installation section by a second pivot and a relative position of the linking engagement member, and capable of swinging synchronously and pivotally with the second operating section, such that when the second operating section swings pivotally to a predetermined angle, an end of the driver is linked and pivoted with the linking engagement member;

at least one stop portion, installed on a side of the second pivot, for limiting a pivoting angle of the second operating section; and

a moving stopper, installed at the second operating section, and situated in a slidable elastic restoration status, and an end of the moving stopper being capable of abutting or disengaging the stop portion by a sliding operation, so as to limit the swing angle of the second operating section and further control the driver whether or not to link and swing the linking engagement member.

Wherein, both of the first and second clamping portions have a quick-replaceable jaw block, and each of the quick-replaceable jaw blocks has a stop groove, and an elastic stop flange is disposed at a relative position of the first and second clamping portions and each of the stop grooves, such that the elastic stop flange is normally abutted against and stopped by the stop groove, and each of the quick-replaceable jaw blocks is situated in a positioned status, and the elastic stop flange can be pressed to withdraw and detach from the stop groove, and then each quick-replaceable jaw block is situated in a detachable and replaceable status.

### BRIEF DESCRIPTION OF THE DRAWINGS

FIG. 1 is a schematic view of a conventional pipe clamp;

FIG. 2 is a perspective view of the whole structure of present invention;

FIG. 3 is an exploded view of a part of the structure of the present invention;

FIG. 4 is an exploded view of a part of the structure of the present invention;

FIG. 5 is a planar view showing the structure of the present invention;

FIG. 6 is a schematic view showing a using status of the present invention;

FIG. 7 is a schematic view showing a using status of the present invention;

and

FIG. 8 is a schematic view showing a using status of the present invention.

### DESCRIPTION OF THE PREFERRED EMBODIMENTS

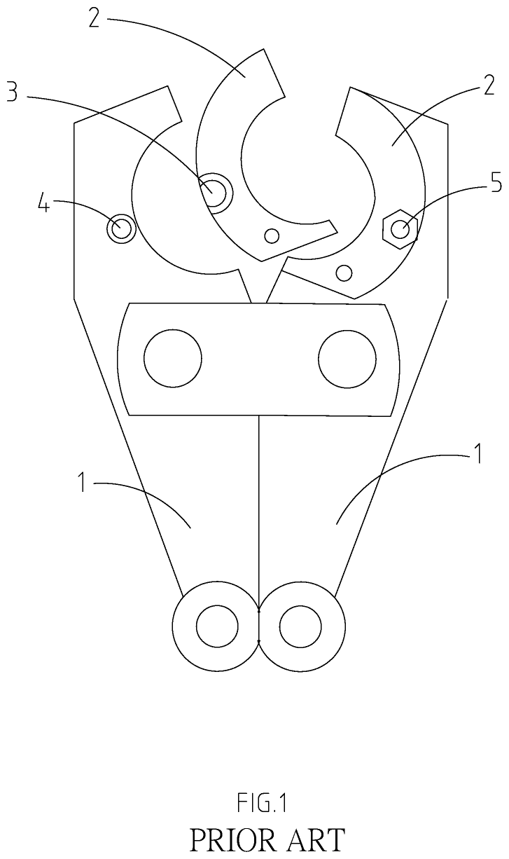

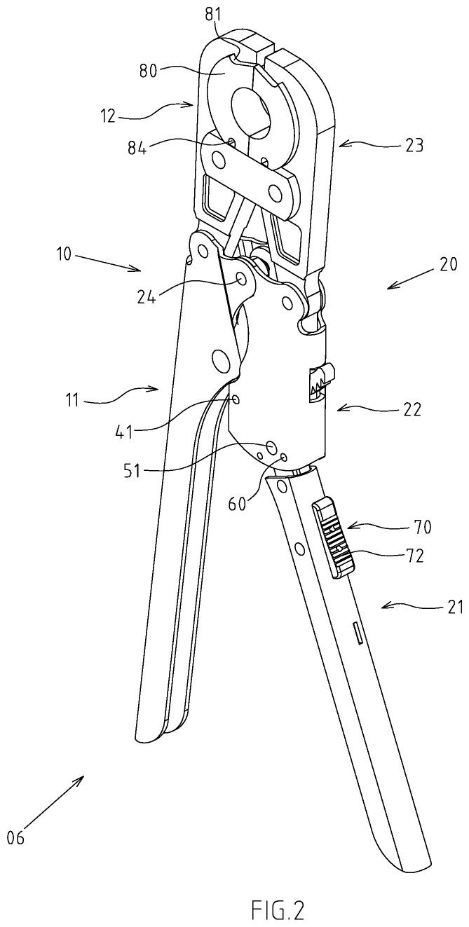

With reference to FIGS. 1 to 4 for a pipe clamp of the present invention, the pipe clamp 06 comprises:

a first clamp body 10, having a first operating section 11 and a first clamp portion 12 disposed at an end of the first operating section 11;

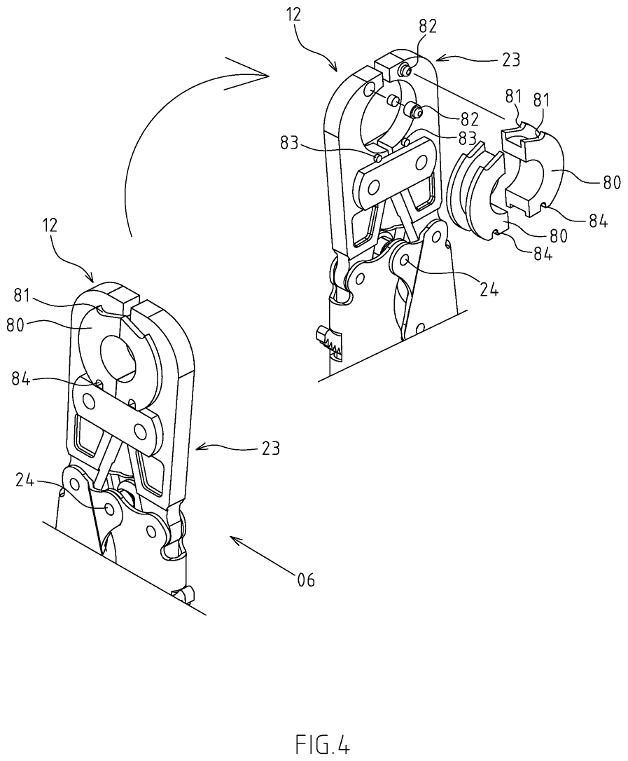

a second clamp body 20, having a second operating section 21, an installation section 22 and a second clamp portion 23 disposed at an end of the installation section 22a, wherein a connector 24 is pivotally installed at a predetermined position of the first and second clamp bodies 10, 20, so that the first and second clamp bodies 10, 20 can swing apart from each other to define an open status or towards each other to define a pressing operation status; and both of the first and second clamping portions 12, 23 in accordance with an embodiment of the present invention as shown in FIG. 4 have a quick-replaceable jaw block 80, and each of the quick-replaceable jaw blocks 80 has a stop groove 81, and an elastic stop flange 82 is disposed at a relative position of the first and second clamping portions 12, 23 and each of the stop grooves 81 (as shown in FIG. 4), such that the elastic stop flange 82 is normally abutted against and stopped by the stop groove 81, and each of the quick-replaceable jaw blocks 80 is situated in a positioned status, and the elastic stop flange 82 can be pressed to withdraw and detach from the stop groove 81, and then each quick-replaceable jaw block 80 is situated in a detachable/replaceable status, so that the quick-replaceable jaw block 80 can be replaced freely without requiring any tool. In addition, the elastic stop flange 82 uses an elastic member such as a spring to achieve the elastic restoring status, but this invention is not limited to such arrangement;

an engaging member 30, installed at the first operating section 11, and having a gear rack 31 disposed on a side of the engaging member 30;

a linking engagement member 40, pivoted to the installation section 22 of the second clamp body 20 by a first pivot 41, and comprising a serrated portion 42 and an elastic element 43, and the elastic element 43 being installed at an end other than the serrated portion 42, so that the linking engagement member 40 can be set into a pivotable and elastically restoring status by using the first pivot 41 as an axis, and the serrated portion 42 is engaged with the gear rack 31 of the engaging member 30 in a one-way engagement limit manner, and if the linking engagement member 30 is in an engaged status, the first and second clamp bodies 10, 20 will be limited to swing in one direction only;

a driver 50, pivoted to the installation section 22 by a second pivot 51 and a relative position of the linking engagement member 40, and capable of swinging synchronously and pivotally with the second operating section 21, such that when the second operating section 21 swings pivotally, an end of the driver 50 is linked and pivoted with the linking engagement member 40;

at least one stop portion 60, disposed on a side of the second pivot 51 for limiting a pivoting angle of the second operating section 21;

a moving stopper 70, installed at the second operating section 21 and situated in a slidable elastic restoration status, and an end of the moving stopper 70 being capable of abutting or disengaging the stop portion 60 by a sliding operation, so as to limit the swing angle of the second operating section 21.

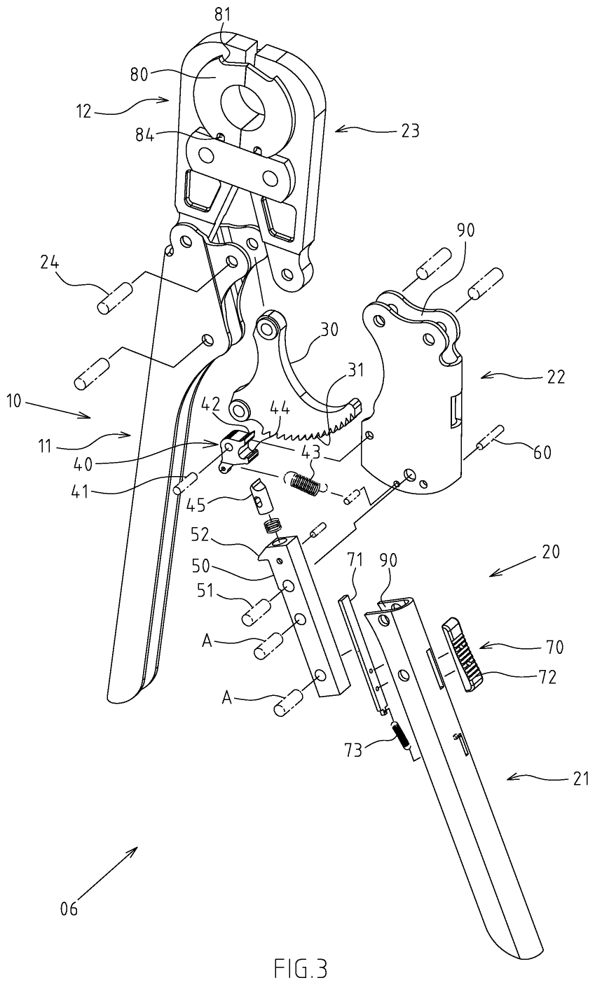

In FIG. 3, both of the second operating section 21 and the installation section 22 have an accommodation space 90 (just marked in FIG. 3 only), and the linking engagement member 40 and the driver 50 are disposed in the accommodation space 90, wherein the driver 50 is substantially in form of an extended block and has a first hook-shaped portion 52 disposed thereon, and an end other than the end with the first hook-shaped portion 52 extending to the accommodation space 90 of the second operating section 21, and then at least one fixing element A is coupled and fixed with the second operating section 21, wherein both of the linking engagement member 40 and the first hook-shaped portion 52 have a second hook-shaped portion 44 disposed at a corresponding position 4.

In FIG. 4, both of the first and second clamping portions 12, 23 have a first guiding portion 83, and a second guiding portion 84 is disposed at a relative position of each of the quick-replaceable jaw blocks 80 and each of the first guiding portions 83, and the first and second guiding portions 83, 84 are configured into a pair consisting of a convex column and a guide groove, so as to improve the convenience of removing and installing each of the quick-replaceable jaw blocks 80.

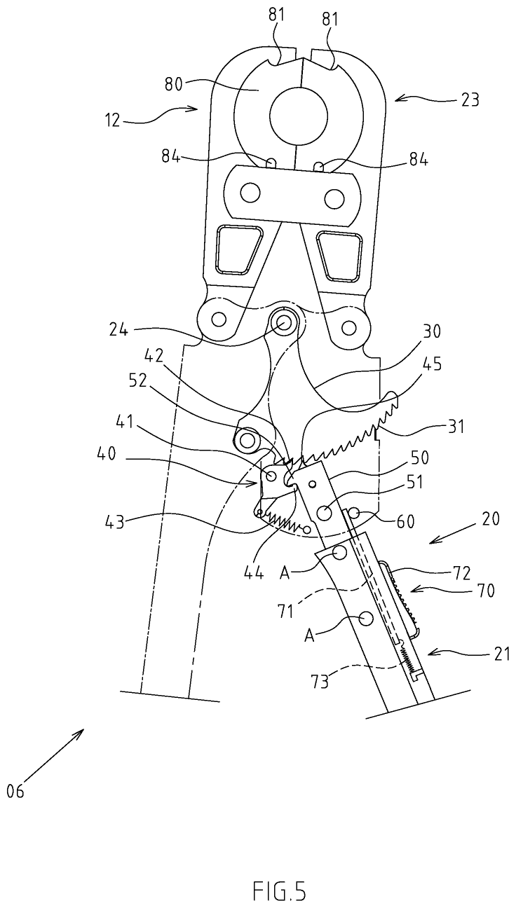

In FIGS. 3 and 5, an elastically withdrawn auxiliary tooth 45 is disposed at an end of the first hook-shaped portion 52 and can be engaged with the gear rack 31 of the engaging member 30 in a one-way engagement limit manner.

In FIGS. 3, 5 and 6, the moving stopper 70 comprises a stop plate 71, a control part 72 and a position restoring member 73 (such as a spring, but not limited thereto), and two opposite ends of the position restoring member 73 are coupled to the second operating section 21 and an end of the stop plate 71, and the control part 72 and the stop plate 71 are substantially situated in a detachable and synchronous status, and the stop plate 71 and the position restoring member 73 are disposed in the accommodation space 90, and the control part 72 is situated outside the accommodation space 90, and the control part 72 can be pushed to link the stop plate 71 to slide along the extending direction of the driver 50 or reset, so as to abut or disengage the stop portion 60. If the stop portion 60 and the stop plate 71 are situated in a separated status, the second operating section 21 will swing to a predetermined angle to approach or to abut the stop portion 60, so as to link the driver 50 with the linking engagement member 40 and separate the serrated portion 42 from the gear rack 31 of the engaging member 30.

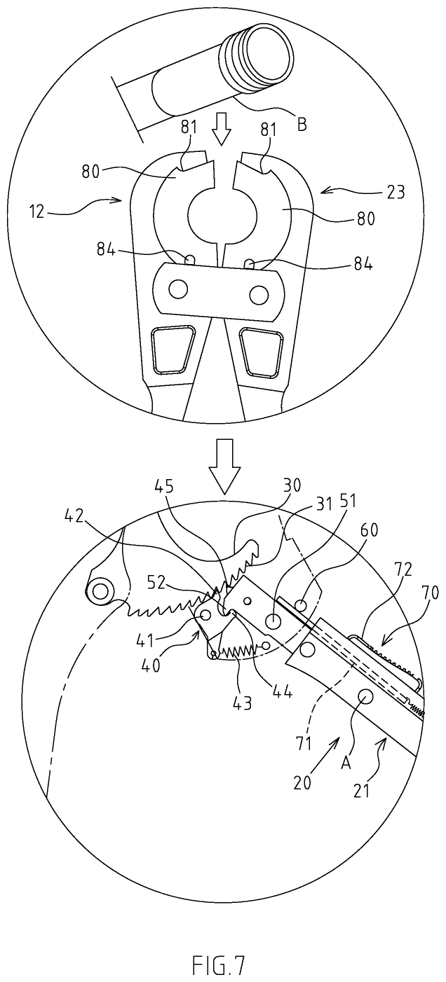

In FIG. 7, the gear rack 31 of the engaging member 30 is in an arc arrangement shape formed along the swing angle of the second clamp body 20, so that when the second operating section 21 and the driver 50 swing synchronously and pivotally, the serrated portion 42 and the gear rack 31 can be swung and engaged at different swing angles.

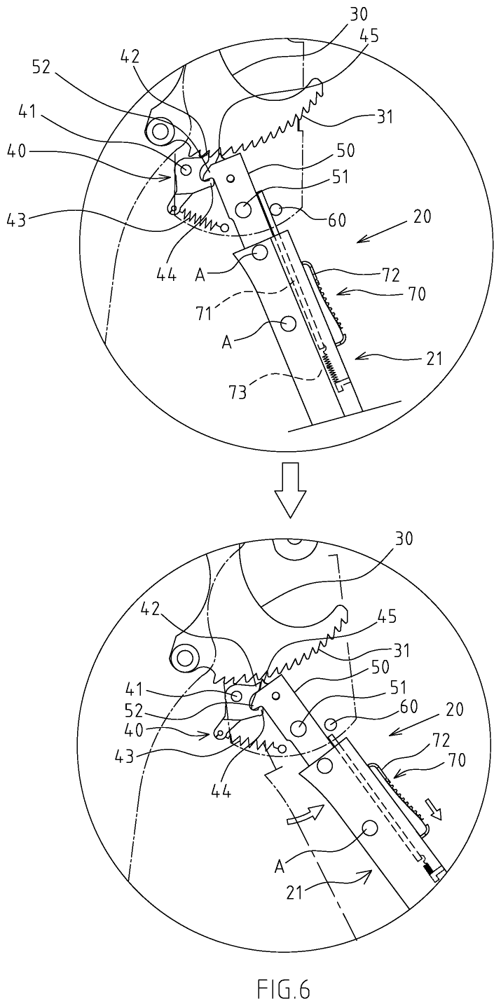

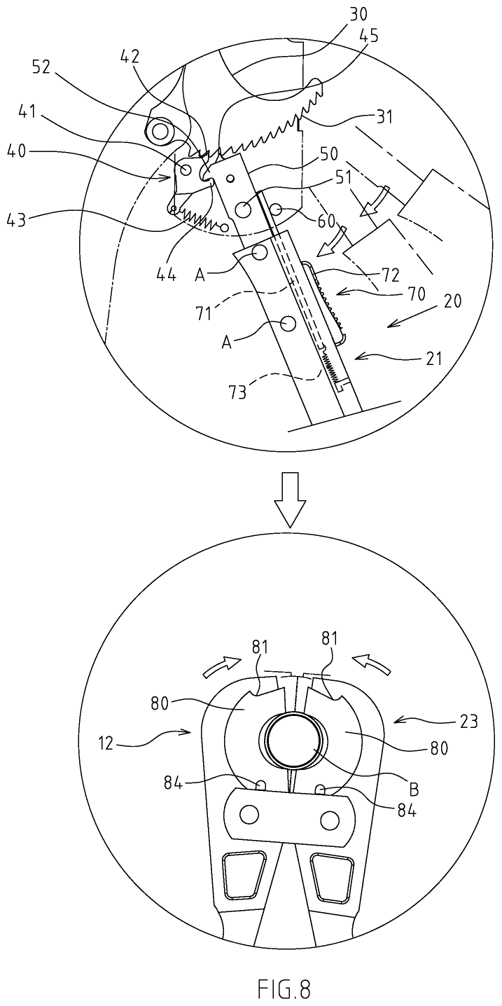

In an application of the present invention as shown in FIGS. 5 to 8, a preset pipe B (such as an oil pipe joint as shown in FIG. 7 or any other pipe fittings, but this invention is not limited thereto) is installed between the quick-replaceable jaw blocks 80, and the first and second operating sections 11, 21 are pressed, so that the first and second operating sections 11, 21 swing pivotally towards the corresponding inner sides, and the quick-replaceable jaw block 80 are abutted and pressed against each other. Now, the serrated portion 42 of the linking engagement member 40 and the gear rack 31 of the engaging member 30 are engaged with each other in one direction only. Even if the first and second operating sections 11, 21 are not pressed anymore, each of the quick-replaceable jaw blocks 80 is still maintained at a tightly pressed position, and will not bounce due to the reaction force. After the pipe clamping operation is completed, the users simply switch the control part 72 of the moving stopper 70 to link and slide the stop plate 71, and spread the first and second operating sections 11, 12 towards the corresponding outer sides (as shown in FIGS. 5 and 6). Now, the stop portion 60 and the stop plate 71 are situated at a separated status, so that the second operating section 21 swings pivotally to a predetermined angle to approach to or abut against the stop portion 60, and the driver 50 is linked with the linking engagement member 40 in order to separate the serrated portion 42 from the gear rack 31 of the engaging member 30. Therefore, the first and second operating sections 11, 12 can be spread to achieve the effects of increasing the force for clamping pipe greatly, preventing loosened parts, and saving laborious efforts.

In addition, if a user needs to change the quick-replaceable jaw block 80, the user will not need a removal too. Compared with the prior art, the present invention simply requires the user to press the elastic stop flange 82 for the withdrawal and separation from the stop groove 81, so that each quick-replaceable jaw block 80 is situated in a detachable and replaceable status. Therefore, the pipe clamp of this invention is applicable for pipes of different sizes and provides a multiple of functions and improves the convenience of use.

The invention claimed is:

1. A pipe clamp, comprising:
a first clamp body, having a first operating section and a first clamp portion disposed at an end of the first operating section;
a second clamp body, having a second operating section, an installation section, and a second clamp portion disposed at an end of the installation section, wherein a connector is pivotally installed at a predetermined position of the first and second clamp bodies, so that the first and second clamp bodies can swing apart from each other to define an open status or towards each other to define a pressing operation status;
an engaging member, installed at the first operating section, and having a gear rack disposed on a side of the engaging member;
a linking engagement member, pivoted to the installation section of the second clamp body by a first pivot, and comprising a serrated portion and an elastic element, and the elastic element being installed at an end other than the serrated portion, so that the linking engagement member can be set into a pivotable and elastically restoring status by using the first pivot as an axis, and the serrated portion is engaged with the gear rack of the engaging member in a one-way engagement limit manner, and if the linking engagement member is in an engaged status, the first and second clamp bodies will be limited to swing in one direction only;
a driver, pivoted to the installation section by a second pivot and a relative position of the linking engagement member, and capable of swinging synchronously and pivotally with the second operating section, such that when the second operating section swings pivotally to a predetermined angle, an end of the driver is linked and pivoted with the linking engagement member;
at least one stop portion, installed on a side of the second pivot, for limiting a pivoting angle of the second operating section; and
a moving stopper, installed at the second operating section, and situated in a slidable elastic restoration status, and an end of the moving stopper being capable of abutting or disengaging the stop portion by a sliding operation, so as to limit the swing angle of the second operating section and further control the driver whether or not to link and swing the linking engagement member.

2. The pipe clamp as claimed in claim 1, wherein both of the first and second clamping portions have a quick-replaceable jaw block, and each of the quick-replaceable jaw blocks has a stop groove, and an elastic stop flange is disposed at a relative position of the first and second clamping portions and each of the stop grooves, such that the elastic stop flange is normally abutted against and stopped by the stop groove, and each of the quick-replaceable jaw blocks is situated in a positioned status, and the elastic stop flange can be pressed to withdraw and detach from the stop groove, and then each quick-replaceable jaw block is situated in a detachable and replaceable status.

3. The pipe clamp as claimed in claim 2, wherein the both of the first and second clamping portions have a first guiding portion, and a second guiding portion is disposed at a relative position of each of the quick-replaceable jaw blocks and each of the first guiding portions, and the first and second guiding portions are configured into a pair consisting of a convex column and a guide groove.

4. The pipe clamp as claimed in claim 1, wherein the second operating section and the installation section has an accommodation space defined therein, and the linking engagement member and the driver are installed in the accommodation space, and the driver is substantially in form of an extended block and has a first hook-shaped portion disposed at an end thereof, and an end other than the end with the first hook-shaped portion extending to the accommodation space of the second operating section, and then at least one fixing element is coupled and fixed with the second operating section, and the linking engagement member and the first hook-shaped portion further have a second hook-shaped portion disposed at a corresponding position.

5. The pipe clamp as claimed in claim 4, wherein the first hook-shaped portion has an elastically withdrawn auxiliary tooth and the auxiliary tooth can be engaged with the gear rack of the engaging member in a one-way engagement limit manner.

6. The pipe clamp as claimed in claim 5, wherein the moving stopper comprises a stop plate, a control part and a position restoring member, and two opposite ends of the position restoring member are coupled to the second operating section and an end of the stop plate, and the control part and the stop plate are substantially situated in a detachable and synchronous status, and the stop plate and the position restoring member are disposed in the accommodation space, and the control part is situated outside the accommodation space, and the control part can be pushed to link the stop plate to slide along the extending direction of the driver or reset, so as to abut or disengage the stop portion, and if the stop portion and the stop plate are situated in a separated status, the second operating section will swing to a predetermined angle to approach or to abut the stop portion, so as to link the driver with the linking engaging member, and separate the serrated portion from the gear rack of the engaging member.

7. The pipe clamp as claimed in claim 1, wherein the gear rack of the engaging member is in an arc arrangement shape formed along the swing angle of the second clamp body, so that when the second operating section and the driver synchronously and swing pivotally, the serrated portion and the gear rack can be swung and engaged at different swing angles.
